(19) United States
(12) Patent Application Publication
(10) Pub. No.: US 2025/0169522 A1
(43) Pub. Date: May 29, 2025

(54) Soft Drink Beverages - Cannabis Flavor

(71) Applicant: Armando G. De La Torre, Santa Ana, CA (US)

(72) Inventor: Armando G. De La Torre, Santa Ana, CA (US)

(21) Appl. No.: 18/458,148

(22) Filed: Nov. 28, 2023

(51) Int. Cl. A23L 2/56; A23L 2/54; A23L 2/60

(52) U.S. Cl. CPC A23L 2/56; A23L 2/54; A23L 2/60

(57) ABSTRACT

The present invention pertains to composition of a cannabis flavoring nonalcoholic, non-cola aqueous carbonated soft drinks and concentrates formulations of various strengths consisting of a coloring, an artificial sweetener to provide a soft drink based on a cannabis flavored drink, which has a refreshment or cooling effect even in the uncooled state.

Carbonated soft drinks or sparkling drinks are soft drinks that are carbonated. During the carbonation process, carbon dioxide (CO2) gas under pressure is dissolved in the soft drink, causing the drink to become effervescent. Carbonation increases in a solution as temperature decreases. The aqueous base carbonated soft drink cannabis flavored concentrate particularly characterized that said carbon dioxide content is volumes carbon dioxide per volume of cannabis flavored concentrate. The aqueous cannabis flavored base carbonated soft drink concentrates as defined as being characterized in that the pH of the concentrate.

The present invention, an aqueous base cannabis flavored soft drink formulation employs concentrated cannabis, an artificial sweetener selected from the group consisting of saccharin and sodium saccharin, depending on the strength of concentrate, and wherein the cannabis flavored concentrate formulation is provided with more than one and up to about seven volumes of carbon dioxide per volume of concentrate.

### BACKGROUND OF THE INVENTION

The present invention relates generally to the improvement to an aqueous base soft drink concentrate formulation with a cannabis flavoring that give the consumer an enhanced refreshing, cooling and relaxation effect upon consumption, and more particularly to such a formulation which is particularly adapted for retention of carbon dioxide. In order to render it possible to have a concentrate cannabis flavored which will receive heavy volumes of CO2, the sweetener is provided in the form of saccharin or sodium saccharin, and sugar. Sugar reduces the amount of carbon dioxide the system will receive and retain under conditions attainable with conventional bottling equipment and containers. The base concentrates contain dissolved carbon dioxide in large quantities and are capable of retaining this dissolved cannabis flavoring concentrate and carbon dioxide because of the artificial sweetener being up to 100% of total sweetener present.

In the past, ordinary sugar has been employed for preparing soft drink concentrates, however with conventional quantities sugar required for preparing a meaningful concentrate, insufficient carbon dioxide was retained, hence the systems were not compatible for the preparation of a carbonated concentrate utilized in preparing a carbonated soft drink with adequate quantities of carbon dioxide present. In normal sugar-based soft drinks, one pound sugar is utilized per gallon of finished product. For relating quantities of sweetener required to be equivalent to sugar-base product, one pound of saccharin has the equivalent sweetening capability of approximately greater than 400 pounds of sugar.

Conventional concentrates of cannabis flavorings and colorings are employed for providing the flavor and color desired, and in addition to the artificial sweeteners, sodium chloride, sodium gluconate, glucona delta lactone is added along with citric acid and sodium citrate, as flavoring and buffering ingredients. To this system, water and CO2 are added and suitable carbonated cannabis flavoring. Under normal conditions, the cannabis flavoring concentrate and carbon dioxide will remain in the concentration, particularly when the concentration is chilled. Upon exposure to the ambience, only modest quantities of carbon dioxide are lost, with the balance being retained in the cannabis flavored soft drink being prepared.

For retention of carbon dioxide, it is preferred that a glass be employed to receive the carbonated cannabis flavored in order to prepare the soft drink. The product is economical for the consumer to utilize and can be packaged or bottled in conventional readily available non-returnable soft drink bottles. The present-day bottling equipment is designed to carbonate the finished product and fill the bottles with a finished product. Present-day equipment makes it mandatory that the composition of the cannabis flavored aqueous solution be compatible with temperature and carbon dioxide pressure of the carbonator. The present arrangement permits greater than four concentrations to bottled or packaged. The present arrangement permits replacement of the sugar with an artificial sweetener such as saccharin or sodium saccharin which permits the carbon dioxide to be absorbed in substantial quantities.

### SUMMARY OF THE INVENTION

Therefore, in accordance with the present invention, an aqueous base cannabis flavored soft drink formulation is provided which employs concentrated cannabis, an artificial sweetener selected from the group consisting of saccharin and sodium saccharin, depending on the strength of concentrate, balance the artificial sweeteners, and wherein the cannabis flavored concentrate formulation. It is a further object of the present enhancement to the invention to provide an aqueous base cannabis flavored soft drink concentrate formulation which has a capability of receiving and retaining substantial quantities of carbon dioxide.

The present invention represents a new composition, method of preparation and applications, above and beyond the prior art, of producing non-cola aqueous carbonated soft drinks. The present invention meets four basic criteria for its purpose (safety, ease-of-use, economic, and desirable) and therefore is useful. Carbonated water is considered a high/medium acid drink. If preferred, the acidity of carbonated soft drinks can be easily adjusted to desirable level by addition of sodium carbonate or potassium carbonate or combination thereof. Cannabis flavored carbonated soft drinks should be prepared in processing plants that meet FDA's Current Good Manufacturing Practices.

Furthermore, the FDA Food Safety Modernization Act (FSMA) aim is to ensure the U.S. food supply is safe by shifting the focus of federal regulators from responding to contamination to preventing it. FSMA includes soft drinks in its regulated products. Processors are required to have Hazard Analysis and Critical Control Points (HACCP) plan or Hazard Analysis and Risk-based Preventive Controls (HARPC) plan in place. While facilities vary, in general, filtration is recommended at the following stages of beverage processing: Incoming source water: Pre-filtration of municipal or spring water to remove sediment, particulates and larger microorganisms; produces industrial water suitable for equipment and container cleaning.

Intermediate processing: Depth filtration through a 10-micron filter to remove smaller particulates and impurities shed during resin or carbon activation steps; specially to preserve integrity of reverse osmosis (RO) membranes. Initial bacterial reduction: Sterile-grade filtration through a 5 micron to 1 micron filter to remove majority of microorganisms potentially present in the water or in containers. Final sterile filtration: Critical filtering through a 0.2-micron filter just prior to packaging; using a sterile-grade membrane filter to capture last surviving microorganisms. In storage: Tank vent filters on stored product in holding tanks; to prevent the ingression of airborne contaminants while equalizing tank pressure as volume changes.

1. The new composition of matter is an improvement to an aqueous base carbonated soft drink cannabis flavored concentrate formulation comprising an aqueous solution of a cannabis flavoring concentrate based upon natural or artificial color or artificial flavor and flavoring constituents selected from the group consisting of sodium chloride, sodium gluconate, glucona delta lactone, caffeine, phosphoric stannous chloride, citric acid, and sodium citrate; sodium benzoate in a concentration in said soft drink concentrate . . .
The aqueous base carbonated soft drink cannabis flavored concentrate as defined as being particularly characterized in that said carbon dioxide content is volumes carbon dioxide per volume of cannabis flavored concentrate. The aqueous cannabis flavored improved base carbonated soft drink concentrates as defined in claim as being particularly characterized in that the pH of the concentrate. An artificial sweetener is provided selected from the group consisting of saccharin and sodium saccharin in a concentration in said cannabis flavored soft drink concentrate by weight based upon total bottled concentrate, and natural sugar, with total sweetening requirement obtained from natural sugar, depending on strength of the concentrate.
Carbon dioxide in a concentration ranging from greater than one up to seven volumes of carbon dioxide per volume of soft drink concentrate wherein the carbonated concentrate is prepared by introducing the carbon dioxide as a gas directly into the cannabis flavored concentrate.
